(19) United States
(12) Patent Application Publication
(10) Pub. No.: US 2010/0226739 A1
(43) Pub. Date: Sep. 9, 2010

(54) System and Method for Transferring Bulk Materials

(75) Inventors: Jon Strimling, Bedford, NH (US); Randell Drane, Winchester, MA (US)

Correspondence Address: GROSSMAN, TUCKER, PERREAULT & PFLEGER, PLLC, 55 SOUTH COMMERICAL STREET, MANCHESTER, NH, 03101, US

(73) Assignee: PELLETSALES.COM, LLC, Goffstown, NH (US)

(21) Appl. No.: 12/718,652

(22) Filed: Mar. 5, 2010

Related U.S. Application Data
(60) Provisional application No. 61/157,776, filed on Mar. 5, 2009.

(51) Int. Cl. B65G 65/30; F16L 11/00; F16L 11/22

(52) U.S. Cl. 414/300; 138/118; 138/114; 414/808

(57) ABSTRACT

A system for transferring bulk solid biomass fuel includes a bin defining a cavity sized and shaped for receiving a quantity of biomass, a trolley configured to engage and travel along a track defining, the track configured to be horizontally mountable to a portion of the bin, a hose having a body coupled to the trolley, at least a portion of the hose configured to be in motion with the trolley, and a means of driving the trolley along the track. A method of transferring bulk solid biomass fuel from a bin, whereby a trolley coupled to a hose is driven along a track, the track being mounted within the bin, conveying the biomass material through the hose, and discharging the material out of the bin and into a receptacle.

### CROSS-REFERENCE TO RELATED APPLICATIONS

This application claims the benefit of the filing date of co-pending U.S. Provisional Patent Application Ser. No. 61/157,776, filed on Mar. 5, 2009 and entitled SYSTEM FOR REMOVING BULK MATERIALS FROM A STORAGE CONTAINER, the teachings all of which are fully incorporated herein by reference.

### TECHNICAL FIELD

The present disclosure relates to a system and method for transferring material, and, more particularly, to a system and method for removing bulk solid biomass fuels from a storage container.

### BACKGROUND

A large number of households, as well as businesses, utilize biomass heating fuel for their heating needs, rather than relying on heating oil, propane and/or electricity. Wood pellets, a type of biomass fuel, are generally made from compacted sawdust and produced as a byproduct of sawmilling and other wood transformation activities. The use of wood pellets as an alternative source of heating fuel has many benefits. Not only are wood pellets a clean, environmentally friendly, natural, and renewable fuel resource, but one ton of wood pellets has the heat value of about one and a half cords of wood and stacks easily in one third the space, making it possible to easily store fuel for an entire season. Pellet fired boilers require facilities for pellet storage, just as oil burners require oil tanks. Because the cost of wood pellets may be more expensive if purchased in small quantities, it is cost effective to purchase pellets more cheaply in larger quantities, and storing pellets in bulk storage systems in a household or business.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 illustrates a perspective view of a transfer system according to one embodiment of the present disclosure;

FIG. 2 illustrates an exploded view of the system of FIG. 1;

FIG. 3 illustrates a perspective view of the system of FIG. 1 having the top closure in an open position, according to another embodiment of the present disclosure;

FIG. 4 illustrates an elevation diagrammatic view of the system of FIG. 1;

FIG. 5 illustrates an enlarged sectional view of an embodiment of the system of FIG. 1;

FIG. 6 illustrates an elevation diagrammatic view of a transfer system, according to another embodiment;

FIG. 7 illustrates an elevation diagrammatic view of a transfer system, according to another embodiment;

FIGS. 8A-C illustrate a bottom view of an embodiment of a transfer system depicting exemplary paths of said system, according to other embodiments consistent with the present disclosure; and

FIG. 9 illustrates an elevation diagrammatic view of a transfer system, according to another embodiment

### DETAILED DESCRIPTION

The subject matter of the present disclosure may involve, in some cases, interrelated products, alternative solutions to a particular problem, and/or a plurality of different uses of a single system or article.

Aspects of the present disclosure relate to a self filling pellet hod configured for moving bulk, i.e., loose, pelletized and/or granularized fuels from a storage bin, which may be remote from an appliance, to an appliance. The fuel may include, but is not limited to, any pelletized and/or granularized solid fuel such as, but coal (e.g., anthracite coal) and biomass fuel. As used herein, biomass fuel is intended to refer to solid animal matter and/or solid fuel plant (such as, but not limited to, numerous types of plants including miscanthus, switchgrass, hemp, corn, poplar, willow, sorghum, sugarcane, a variety of tree species, and/or torrefied biomass fuel, e.g., e-coal or eco-coal) that can be combusted as fuel. The term biomass fuel is not intended to refer to fossil fuels which have been transformed by geological processes into substances, such as coal, petroleum or natural gas. Although fossil fuels have their origin in ancient biomass, they are not considered biomass fuel as used herein and by the generally accepted definition because they contain carbon that has been “out” of the carbon cycle for a very long time. Bulk as used herein may refer to a quantity loose of fuel that is not associated with a fixed size, e.g., forty pound bag. In other words, the material may be loose and not in bags. Although, in the exemplary embodiments described below, reference is made to biomass fuel (e.g., wood pellets, the systems and method may be used with any bulk solid biomass fuel.

Biomass heating fuel (e.g., wood pellets) may be purchased in fixed size bags, e.g., by weight or volume, or in bulk, i.e., loose. Bags may provide a convenient method for storing and/or manually moving a quantity of biomass heating fuel. Bags may generally be sized so that the contents of at least one bag may fit into a fuel reservoir of a biomass appliance, e.g., a pellet stove. Such bag sizing may provide convenience in that partial bags need not be accommodated. Standard bags are generally sized to contain about forty pounds of biomass heating fuel. However, forty pounds may be too heavy for some people to lift and/or carry.

A further disadvantage of bags is waste from packaging (i.e., the bags themselves). Providing bulk biomass heating fuels may eliminate such packaging waste. However, eliminating the bags may also eliminate a convenient way of transferring the biomass fuel from, e.g., a storage container to the appliance. It may therefore be desirable to provide a way to remove an adjustable quantity of biomass fuel from the storage container for transfer to the heating appliance.

The present disclosure relates to a system and method for transferring bulk solid biomass fuel from a storage container, the system comprising a bin defining a cavity sized and shaped for receiving a quantity of bulk solid biomass fuel, a trolley configured to engage and travel along a track configured to be generally horizontally mounted to a portion of the bin, a hose coupled to the trolley, at least a portion of the hose configured to be in motion with the trolley, a vacuum source coupled to the hose, and a means of driving the trolley along the track. It should be noted that in some embodiments, a trolley may not be necessary in order to transfer the bulk solid biomass fuel, particularly when transferring biomass fuel from a relatively small storage container. The present disclosure may also further comprise conveying the bulk solid biomass fuel through the hose and discharging the bulk solid biomass fuel to a desired receptacle, which may include a heating appliance, such as a wood pellet stove.

The present disclosure may eliminate the need to carry individual forty-pound bags of biomass heating fuel, or other material, to a desired appliance/receptacle, such as a wood pellet stove. The present disclosure may also eliminate any packaging waste resulting from the continual use of bagged biomass heating fuels. The present disclosure may provide a means of transferring an adjustable quantity of bulk solid biomass fuel from a storage container to a heating appliance.

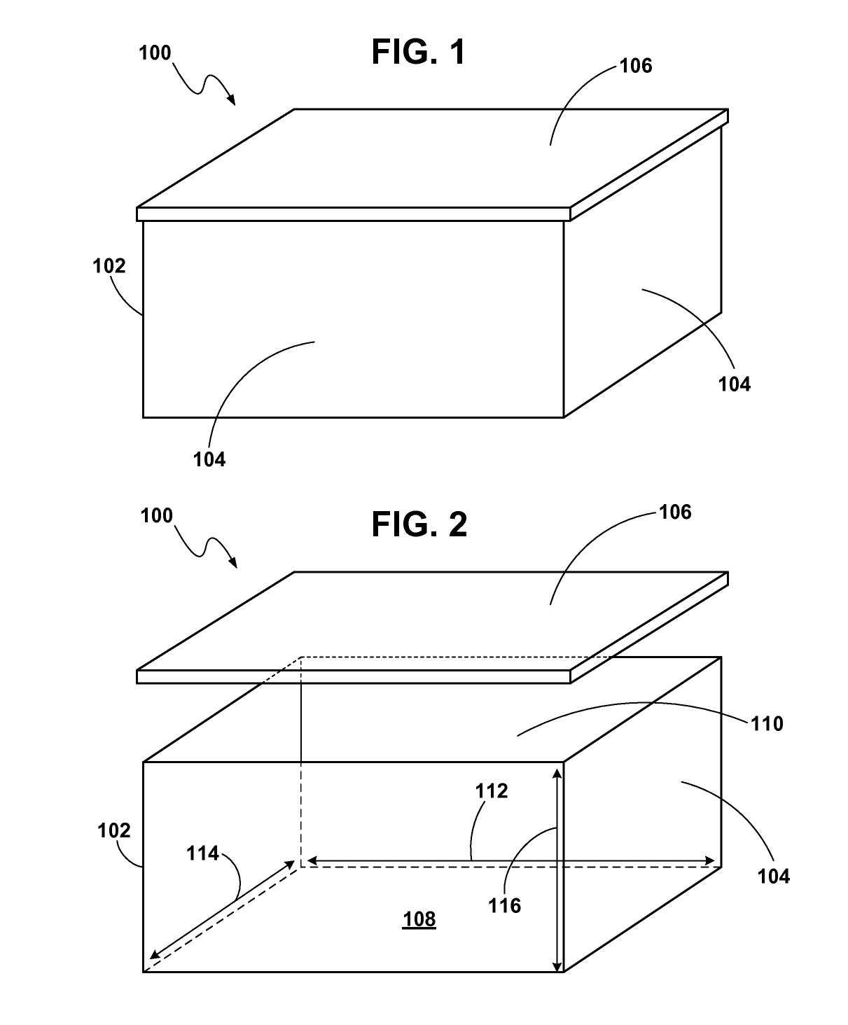

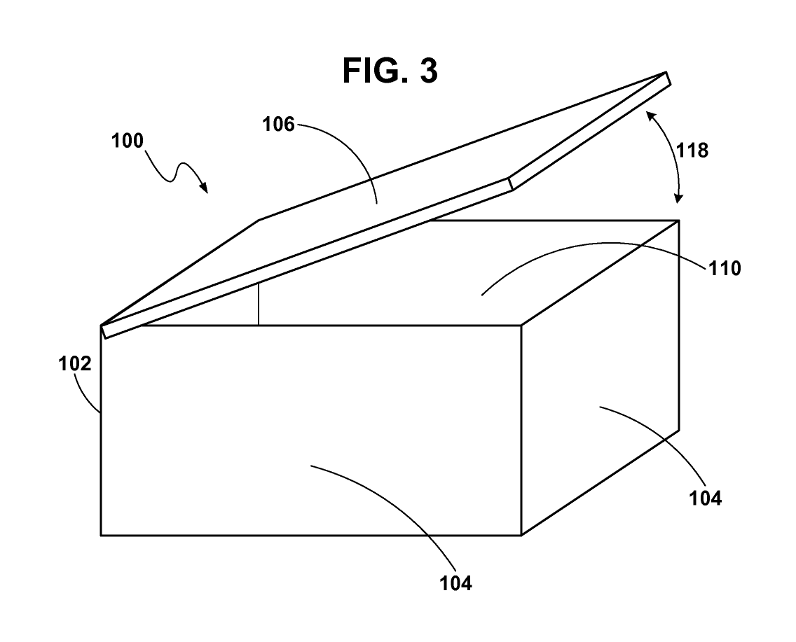

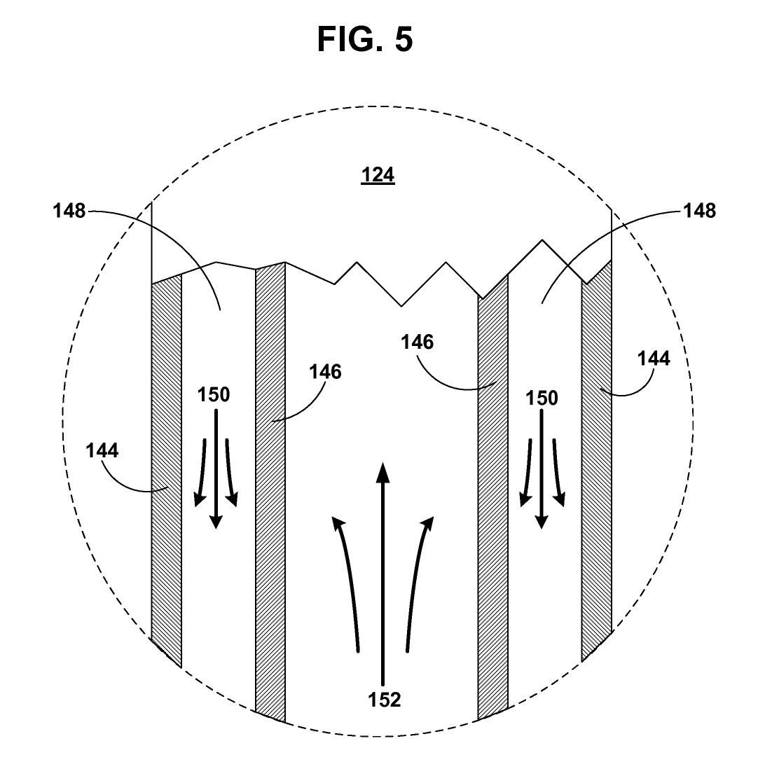

FIG. 1 generally depicts a perspective view of a transfer system 100 consistent with one embodiment of the present disclosure. Generally, system 100 may include a bin 102 having one or more side walls 104, a floor (for example, as shown in FIG. 2), and a top closure 106. FIG. 2 depicts an exploded view of the system 100 of FIG. 1. As shown in FIG. 2, system 100 may include a bin 102 having side walls 104, a floor 108, and a top closure 106. The sidewalls 104 and floor 108 may partially define a cavity 110 sized and shaped for receiving and storing a quantity of biomass (for example, as generally shown in FIGS. 4 and 6-7). The cavity 110 may define a length 112, a width 114, and a height 116. The bin 102 may be a flat bottom pellet bin, sized and shaped to hold a quantity of bulk material, such as wood pellets. In other embodiments, the bin 102 may be any type of storage container configured to adequately hold a quantity of bulk material. The bin 102 may also include a dedicated room.

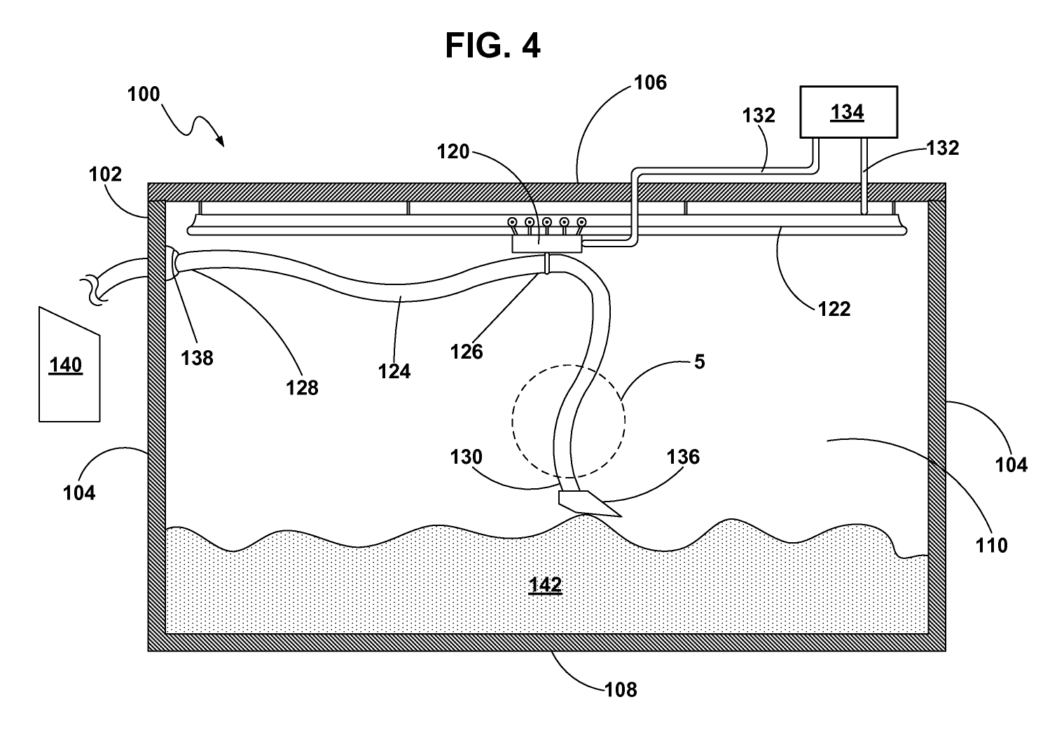

FIG. 3 depicts a perspective view of the system 100 of FIG. 1 having the top closure 106 in an open position 118. In this embodiment, system 100 may include a bin 102 having side walls 104, a floor (as generally shown in FIG. 2), and a top closure 106 in an open position 118. The sidewalls 104 and floor (shown in FIG. 2) may partially define a cavity 110 sized and shaped for receiving and storing a quantity of biomass (shown in FIGS. 4 and 6-7). While the top closure 106 is shown being removably with respect to the side walls 103 and floor 108, it should be noted that this is for illustrative purposes and one or more of the side walls 103 and/or floor 108 (or any portion thereof) may be removable.

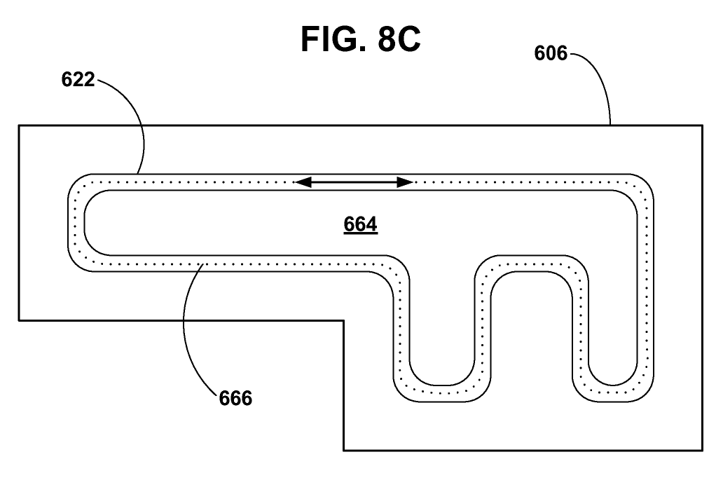

FIG. 4 depicts an elevation diagrammatic view of the system of FIG. 1 containing a quantity of bulk solid biomass fuel 142. The system 100 may include a trolley 120 configured to engage and travel along a track 122 defining a path (shown in FIGS. 8A-8C). The track 122 may be configured to be generally horizontally mounted to a portion of the top closure 106. In one embodiment, the track 122 may be horizontally mounted to a portion of an interior surface (shown in FIGS. 8A-8C) of the top closure 106. The system 100 may also include a hose 124 having a body 126 coupled to the trolley 120, wherein at least a portion of the hose 124 may be configured to be in motion with the trolley. The hose 124 may be comprised of a flexible and durable material.

The hose body 126 may define a first end 128 and a second end 130, wherein the first end 128 may be configured to be in fluid communication with second end 130. At least a portion of the first end 128 of the hose 124 may be coupled to a discharge port 138 defined on the bin 102. The system 100 may also include a driving mechanism 132 configured to drive the trolley 120 along the track 122.

In one embodiment, the driving mechanism 132 may be coupled to and powered by a motor 134. The motor 134 may be electric, non-electric, hydraulic, actuator, magnetic, pneumatic, or combinations thereof. In one embodiment, the track 122 may be coupled to and driven by the drive mechanism 132, wherein the track 122 may be configured to engage and drive the trolley 120 along the path (shown in FIGS. 8A-8C). In another embodiment, the trolley 120 may be coupled to and driven by drive mechanism 132.

The track 122 and trolley 120 may be configured to operate with one another in any manner generally known to one skilled in the art. For example, the track 122 may include spaced flanges (not shown) defining a track slot (not shown), wherein the trolley 120 may include radial wheels mounted in laterally spaced tandem pairs on a trolley body for rotation about parallel horizontal axes, wherein the wheels may be rollingly engaging the track flanges. The trolley 120 may also include guide rollers positioned in the track slot and may guide the trolley 120 along the track 122. In other embodiments, the trolley 120 may include slide discs, canted rotatable wheels, wheels rotatable about vertical axes, spherical ball arrangements, radial wheel arrangements, or combinations thereof.

The system 100 of FIG. 4 may further include an end effector 136 coupled to at least a portion of second end 130 of the hose 124, wherein the end effector 136 may be configured to be in fluid communication with the first end 128 of the hose 124. The end effector 136 may be configured to engage the bulk solid biomass fuel 142. In one embodiment, the end effector 136 may be shaped and sized to allow greater contact surface, as well as continual contact, with the bulk solid biomass fuel 142. For example, in the end effector may have a substantial amount of weight, as well as a large surface area.

The system 100 of FIG. 4 may also include a receptacle 140 configured to collect bulk solid biomass fuel 142 that may be conveyed through the hose 124 by way of a vacuum source (not shown) coupled to the hose 124, and discharged through the first end 128 of the hose 124 and the discharge port 138. In one embodiment, the receptacle 140 may be remotely located outside of the bin 102. In one embodiment, the receptacle 140 may comprise a heating appliance, including a wood pellet stove. In other embodiments, the receptacle may comprise a transfer mechanism, such as a transfer hopper, from which the biomass fuel may then be transferred to a heating appliance, including a wood pellet stove.

The bin 102 may contain a variable quantity of bulk solid biomass heating fuel 142. For example, early in a heating season or immediately following a delivery of biomass heating fuel, the bin may be relatively full. As the bulk solid biomass fuel is consumed, a relatively smaller quantity may remain in the bin 102. During operation, the end effector 136 may be dragged along the biomass material 132 by the hose 124. The end effector 136 may collect bulk solid biomass fuel 142 (e.g., wood pellets) that may then be conveyed from the bin 102 to the receptacle 140. The end effector 136 may be configured to collect bulk solid biomass fuel 142 within a volume based, at least in part, on a shape of the end effector. As the trolley 120 moves along the track 122, the end effector 136 may be dragged along a second path (not shown) that depends, at least in part, on the path (shown in FIGS. 8A-8C) of the trolley 120. In one embodiment, the end effector 136 may be configured to deviate from the path of the trolley in order to traverse a greater portion of an area of the bin.

The system 100 may be configured such that the end effector 136 and at least a portion of the hose 124 may be “buried” during a delivery of bulk solid biomass fuel 142. In one embodiment, the system 100 may be configured to allow the end effector 136 to begin to collect bulk solid biomass fuel 142 while buried. In another embodiment, the system 100 may be configured to allow the end effector 136 to collect bulk solid biomass fuel 142 while positioned on a surface of the bulk solid biomass fuel 142 (shown in FIGS. 4 and 6-7). The end effector 136 may be configured to collect substantially all of the remaining bulk solid biomass fuel 142 when the bin 102 is nearly empty, i.e., may be configured to substantially clean the floor 108 of the bin 102.

In another embodiment, the end effector may include a feature, e.g. a tail (not shown), that provides a steering function to control the motion of the end effector. For example, the tail may be configured to steer the end effector based on a position of the end effector relative to the bulk solid biomass fuel 142. In another example, the tail may be configured to steer the end effector based on a position of the end effector relative to a direction of motion of a trolley 120. In this manner, the end-effector may more effectively cover a volume and/or area of the bin 102.

When pneumatically conveying solid material, such as bulk solid biomass fuel 142, it may be desirable to provide a pulsed flow of solids and/or air, which may increase a distance that the solids may be conveyed. The term “pulsed flow” may be understood as a periodic flow with an associated duty cycle. For example, a combination of air and solids may flow for a first portion of a cycle and substantially all air may flow for a second portion of the cycle. It may further be desirable to allow for reversing of flow in order to purge a hose containing solids.

In one embodiment, the system may be configured to provide a pulsed flow of bulk solid biomass fuel 142 and/or air. For example, while the end effector is in motion, i.e., while the end effector is being pulled by the hose and/or trolley, and the vacuum source is activated, the end-effector may collect bulk solid biomass fuel 142. The bulk solid biomass fuel 142 may then be pneumatically conveyed through the hose to an appropriate receptacle. Continuing with this example, if the trolley is paused on its path, the end effector may also substantially stop moving. The end effector may be configured to create a “pocket” within the bulk solid biomass fuel 142 (i.e., a volume of air without bulk solid biomass fuel 142) when it is not moving and when the vacuum source is activated. In this manner, a pulsed flow of bulk solid biomass fuel 142 may be generated. The duty cycle of the pulsed flow may depend on a configuration of the end effector and/or relative paused and in motion time intervals of the trolley and/or end-effector.

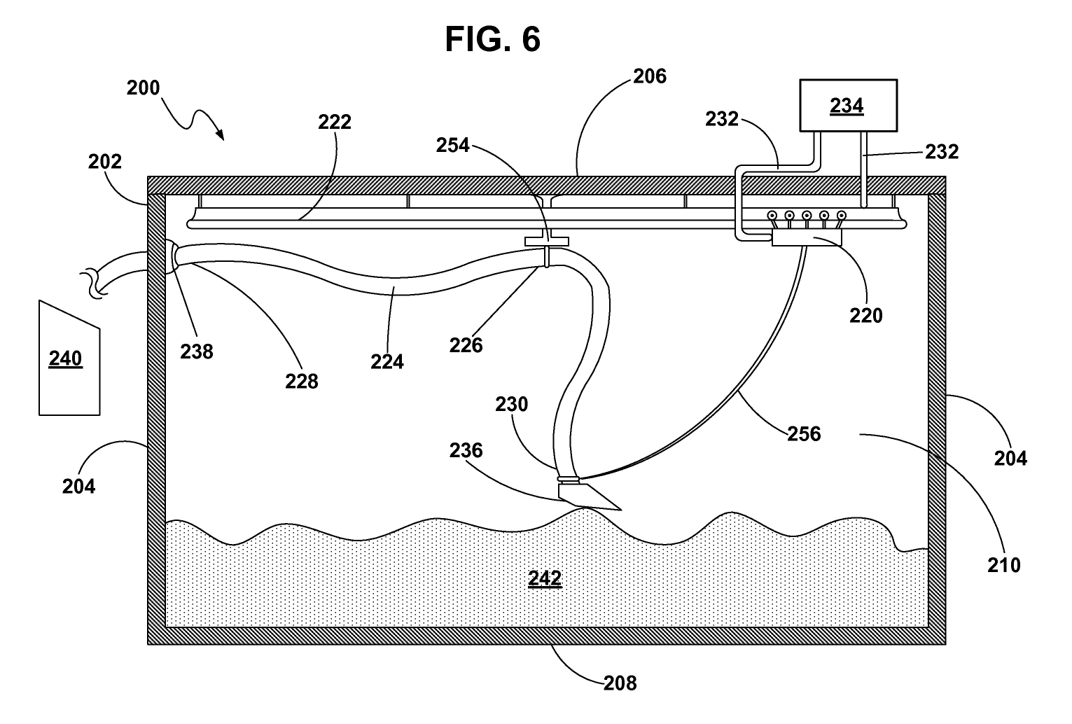

FIG. 5 depicts an enlarged sectional view of an embodiment of the system of FIG. 1, consistent with one embodiment of the present disclosure. As can most clearly be seen in FIG. 5, hose 124 may comprise and inner hose 146 coaxially (e.g., side-by-side) contained within an outer hose 144. A region 148 may be defined between the inner hose 146 and outer hose 144. In one embodiment, a positive pressure source (not shown) may be coupled to the outer hose 144 and the region 148 may be configured to channel the positive pressure 150. A negative pressure source (not shown) may be coupled to the inner hose 146 and negative pressure 152 may flow through the inner hose 146. During operation, the positive pressure flow 150 may help loosen any bulk solid biomass fuel 142 adjacent the end effector (shown in FIGS. 4 and 6-7) and may direct at least a portion of the loosened bulk solid biomass fuel 142 toward the inner hose 146.

In one embodiment, the inner hose 146 may be configured to provide a negative pressure and/or suction at the end effector. The end effector may be configured to direct the bulk solid biomass fuel 142 toward the inner hose 146. The bulk solid biomass fuel 142 and/or air may then flow from the end effector into the inner hose and thereby be transferred through the hose to the receptacle.

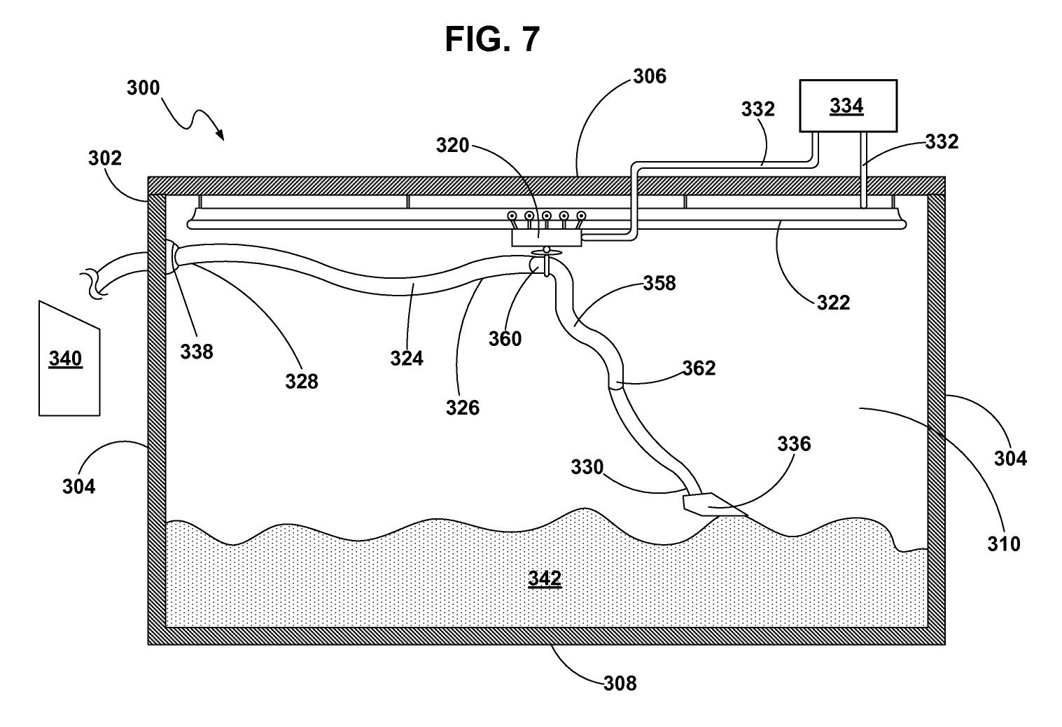

FIG. 6 depicts an elevation diagrammatic view of a transfer system 200, consistent with another embodiment of the present disclosure. This embodiment is similar to the embodiment of FIG. 4, and like components have been assigned like reference numerals. As shown in FIG. 6, system 200 may include a bin 202 having side walls 204, a floor 208, and a top closure 206. The sidewalls 204 and floor 208 may partially define a cavity 210 sized and shaped for receiving and storing a quantity of bulk solid biomass fuel 242. The system 200 may also include a trolley 220 configured to engage and travel along a track 222 defining a path (shown in FIGS. 8A-8C). The track 222 may be configured to be horizontally mounted to a portion of the top closure 206. In one embodiment, the track 222 may be horizontally mounted to a portion of an interior surface (shown in FIGS. 8A-8C) of the top closure 206. The system 200 may also include a hose 224 having a body 226 directly coupled to a fixed hose mount 254. The hose mount 254 may be configured to be horizontally mounted to a portion of the top closure 206. In one embodiment, the hose mount 254 may be horizontally mounted to a portion of an interior surface (shown in FIGS. 8A-8C).

The hose body 226 may define a first end 228 and a second end 230, wherein the first end 228 may be configured to be in fluid communication with second end 230. At least a portion of the second end 230 may be coupled to the trolley 220 by a coupling means 256. In one embodiment, the coupling means 256 may comprise a pulling wire. At least a portion of the first end 228 of the hose 224 may be coupled to a discharge port 238 defined on the bin 202. The hose 224 may be comprised of a flexible and durable material. The system 200 may also include a driving mechanism 232 configured to drive the trolley 220 along the track 222.

In one embodiment, the driving mechanism 232 may be coupled to and powered by a motor 234. The motor 234 may be electric, non-electric, hydraulic, actuator, magnetic, pneumatic, or combinations thereof. In one embodiment, the track 222 may be coupled to and driven by the drive mechanism 232, wherein the track 222 may be configured to engage and drive the trolley 220 along the path (shown in FIGS. 8A-8C). In another embodiment, the trolley 220 may be coupled to and driven by drive mechanism 232.

The system 200 of FIG. 6 may further include an end effector 236 coupled to at least a portion of second end 230 of the hose 224, wherein the end effector 236 may be configured to be in fluid communication with the first end 228 of the hose 224. The end effector 236 may be configured to engage the bulk solid biomass fuel 242. The system 200 may also include an appliance/receptacle 240 configured to collect bulk solid biomass fuel 242 that may be conveyed through the hose 224 by way of a vacuum source (not shown) coupled to the hose 224, and discharged through the first end 228 of the hose 224 and the discharge port 238. In one embodiment, the appliance/receptacle 240 may be remotely located outside of the bin 202. The appliance/receptacle 240 may comprise a heating appliance, including a wood pellet stove.

During operation, the end effector 236 may be dragged along the bulk solid biomass fuel 242 by the coupling means 256, e.g. pulling wire. As the trolley 220 moves along the track 222, the end effector 236 may be dragged along a second path (not shown) that depends, at least in part, on the path (shown in FIGS. 8A-8C) of the trolley 220. It should be noted that in some embodiments, the coupling means 256 may vertically raise and/or lower the end effector 236, such that the end effector 236 may be lifted out of the bulk solid biomass fuel 242 during delivery of additional bulk solid biomass.

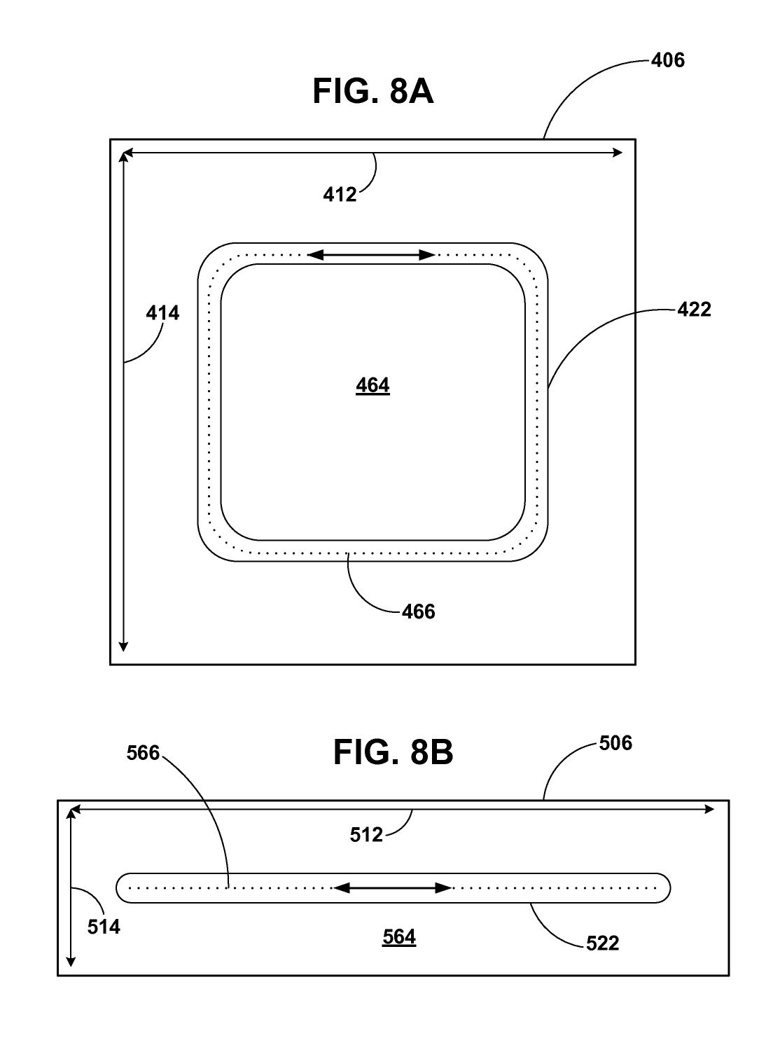

FIG. 7 depicts an elevation diagrammatic view of a transfer system 300, consistent with another embodiment of the present disclosure. This embodiment is similar to the embodiment of FIG. 4, and like components have been assigned like reference numerals. Generally, system 300 may include a bin 302 having side walls 304, a floor 308, and a top closure 306. The sidewalls 304 and floor 308 may partially define a cavity 310 sized and shaped for receiving and storing a quantity of bulk solid biomass fuel 342. The system 300 may also include a trolley 320 configured to engage and travel along a track 322 defining a path (shown in FIGS. 8A-8C). The track 322 may be configured to be horizontally mounted to a portion of the top closure 306. In one embodiment, the track 322 may be horizontally mounted to a portion of an interior surface (shown in FIGS. 8A-8C) of the top closure 306.

The system 300 may also include a hose 324 having a body 326 coupled to an S-pipe 358, wherein the S-pipe 358 has a proximal end 360 and a distal end 362. At least a portion of the proximal end 360 may be rotatably coupled to the trolley 320 and at least a portion of the distal end 362 may be coupled to at least a portion of the hose 324. The S-pipe 358 may be configured to rotate about an axis substantially perpendicular to the trolley 320. The shape of the S-pipe 358 may be substantially sigmoid, i.e., S-shaped and the S-pipe 358 may be comprised of a substantially rigid and durable material. In some embodiments, rotary couplings may be coupled to at least one of the ends of the S-pipe.

The hose body 326 may define a first end 328 and a second end 330, wherein the first end 328 may be configured to be in fluid communication with second end 330. At least a portion of the first end 328 of the hose 324 may be coupled to a discharge port 338 defined on the bin 302. The hose 324 may be comprised of a flexible and durable material. The system 300 may also include a driving mechanism 332 configured to drive the trolley 320 along the track 322.

In one embodiment, the driving mechanism 332 may be coupled to and powered by a motor 334. The motor 334 may be electric, non-electric, hydraulic, actuator, magnetic, pneumatic, or combinations thereof. In one embodiment, the track 322 may be coupled to and driven by the drive mechanism 332, wherein the track 322 may be configured to engage and drive the trolley 320 along the path (shown in FIGS. 8A-8C). In another embodiment, the trolley 320 may be coupled to and driven by drive mechanism 332.

The system 300 of FIG. 7 may further include an end effector 336 coupled to at least a portion of second end 330 of the hose 324, wherein the end effector 336 may be configured to be in fluid communication with the first end 328 of the hose 324. The end effector 336 may be configured to engage the bulk solid biomass fuel 342. The system 300 may also include a receptacle 340 configured to collect bulk solid biomass fuel 342 that may be conveyed through the hose 324 by way of a vacuum source (not shown) coupled to the hose 324, and discharged through the first end 328 of the hose 324 and the discharge port 338. In one embodiment, the receptacle 340 may be remotely located outside of the bin 302. The receptacle 340 may comprise an appliance, including a wood pellet stove.

During operation, the end effector 336 may be dragged along the bulk solid biomass fuel 342 by the hose 324. As the trolley 320 moves along the track 322, the end effector 336 may be dragged along a second path (not shown) that depends, at least in part, on the path (shown in FIGS. 8A-8C) of the trolley 320. In one embodiment, rotation of the S-pipe 358 may be controlled by a controller. For example, the S-pipe 358 may be configured to adjust a path of the end effector 336 relative to the path of the trolley 320. In another embodiment, the S-pipe 358 may rotate based, at least in part, on a motion of the end effector 336 dragging along bulk solid biomass fuel 342.

FIGS. 8A-C depict a bottom view of an embodiment of a transfer system depicting exemplary paths of said system, according to other embodiments consistent with the present disclosure. These embodiments are similar to the embodiment of FIG. 4, and like components have been assigned like reference numerals. As can most clearly be seen in FIG. 8A, top closure 406 may define an interior surface 464. The interior surface 464 may define a length 412 and width 414 corresponding to the interior cavity length and width of a bin (shown in FIG. 2), respectively. As shown in FIG. 8A, a track 422 may be horizontally mounted to the interior surface 464 of the top closure 406, wherein the track 422 may define a trolley path 466. The path 466 may be configured to direct an end effector (not shown) to traverse the length 412 and the width 414. The trolley path 466 may be configured to allow the end effector to traverse substantially all of the horizontal dimensions, i.e., the corresponding length(s) and width(s), of a bin. Accordingly, the trolley path 466 may be defined based on a shape of a bin.

As shown in FIG. 8B, top closure 506 may define an interior surface 564. The interior surface 564 may define a length 512 and width 514 corresponding to the interior cavity length and width of a bin (shown in FIG. 2), respectively. As shown in FIG. 8B, a track 522 may be horizontally mounted to the interior surface 564 of the top closure 506, wherein the track 522 may define a trolley path 566. The path 566 may be configured to direct an end effector (not shown) to traverse the length 512 and the width 514.

As shown in FIG. 8C, top closure 606 may define an interior surface 664. The interior surface 664 may have a relatively complex dimension, which may include multiple lengths and widths directly corresponding to dimensions of an interior cavity of a bin (not shown). As shown in FIG. 8C, a track 622 may be horizontally mounted to the interior surface 664 of the top closure 606, wherein the track 622 may define a trolley path 666. The path 666 may be configured to direct an end effector (not shown) to traverse all horizontal dimensions (not shown).

In one embodiment, as shown in FIG. 8A, the interior surface 464 of the top closure 406 may define approximately equal length 412 and width 414 dimensions. In another embodiment, as shown in FIG. 8B, the interior surface 564 of the top closure 506 may define a length 512 that is relatively greater than a width 514. In another embodiment, as shown in FIG. 8C, the interior surface 664 of the top closure 606 may define a relatively complex shape, i.e., that is not substantially rectangular.

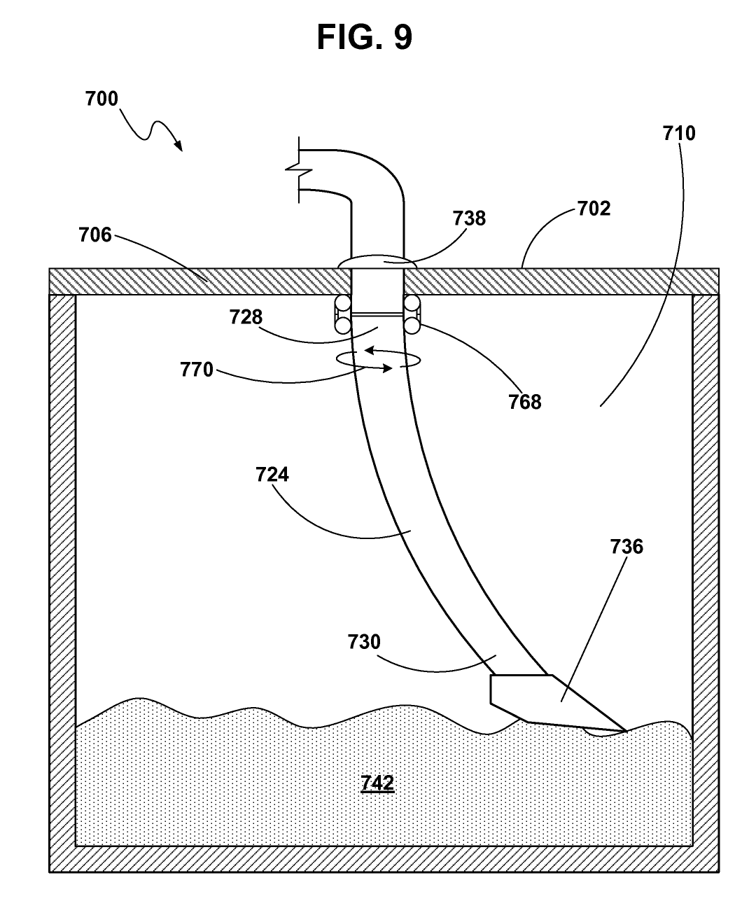

FIG. 9 depicts an elevational view of a transfer system 700, consistent with another embodiment of the present disclosure. This embodiment is similar to the embodiment of FIG. 4, and like components have been assigned like reference numerals. As shown in FIG. 9, system 700 may include a bin 702 having an interior cavity 710 sized and shaped for receiving and storing a quantity of bulk solid biomass fuel 742. The system 700 may also include a hose 724 coupled to bearings 768, wherein the bearings 768 may be fixed to the top closure 706 of the bin 702. The term “bearing” refers to a device that allows relative motion between two or more parts, typically rotation or linear movement. The bearing may permit axial rotation, linear motion, spherical rotation, hinge motion, and/or combinations thereof. The bearing may be selected from the group consisting of plain bearing, rolling-element bearing, jewel bearing, fluid bearing, magnetic bearing, and flexure bearing.

In one embodiment, the bearings 768 may be horizontally mounted to a portion of an interior surface (shown in FIGS. 8A-8C). At least a portion of the hose 724 may be able to freely rotate 770 about an axis substantially perpendicular to the bearings 768 and/or top closure 706. The rotation may be either free rotation and/or may be driven by a gear or other actuator (not shown). The hose 724 may define a first end 728 and a second end 730, wherein the first end 728 may be configured to be in fluid communication with second end 730. At least a portion of the first end 728 of the hose 724 may be coupled to a discharge port 738 defined on the bin 702. In one embodiment, the discharge port 738 may be defined on the top closure 710.

The system 700 of FIG. 9 may further include an end effector 736 coupled to at least a portion of second end 730 of the hose 724, wherein the end effector 736 may be configured to be in fluid communication with the first end 728 of the hose 724. The end effector 736 may be configured to engage the bulk solid biomass fuel 742.

The system 700 may also include a track and trolley system (shown in FIGS. 4 and 6-7), wherein at least a portion of the hose 724 may be coupled to the trolley, the trolley may be configured to engage and travel along a track defining a path (shown in FIGS. 8A-8C). The track may be configured to be horizontally mounted to a portion of the bin. The system 700 may also include a driving mechanism (shown in FIGS. 4 and 6-7) configured to drive the trolley along the track.

In other embodiments, the system 700 of FIG. 9 may further include an S-pipe (shown in FIG. 7) coupled to the bearings, wherein the S-pipe may be able to freely rotate about an axis substantially perpendicular to the bearings and/or top closure. At least a portion of the hose may be coupled to the S-pipe. The S-pipe may be coupled to a trolley. The S-pipe may freely rotate and/or may be driven by a gear, airflow, or other mechanism.

In one aspect, the present disclosure may feature an apparatus. The apparatus may comprise a hose having a body defining a first end and a second end, the first end configured to be in fluid communication with the second end, and a driving mechanism configured to move the hose in at least one direction.

In another aspect, the present disclosure may feature a transfer system for bulk solid biomass fuel. The system may comprise a bin having an interior cavity sized and shaped for receiving a quantity of biomass, the cavity defining a length, a width, and a height, a trolley configured to engage and travel along a track defining a path, the track configured to be horizontally mountable to a portion of the bin, a hose having a body coupled to the trolley, at least a portion of the hose configured to be in motion with the trolley, the body defining a first end and a second end, the first end configured to be in fluid communication with the second end, and a driving mechanism configured to move the hose in at least one direction.

In yet another aspect, the present disclosure may feature a method of transferring bulk solid biomass fuel. The method may comprise providing a trolley configured to engage and travel along a track defining a path, the track configured to be horizontally mountable, the trolley being coupled to a hose, the hose having a body defining a first end and a second end configured to be in fluid communication with the first end, wherein at least a portion of the hose is configured to be in motion with the trolley and configured to engage and convey a quantity of biomass material, providing a driving mechanism configured to drive the trolley along the track, driving the trolley along the track, and conveying the biomass material through the hose.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto; the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications and publications that are cited or referred to in this application are incorporated in their entirety herein by reference.

Additional disclosure in the format of claims is set forth below:

1. An apparatus comprising:
a hose having a body defining a first end and a second end, said first end configured to be in fluid communication with said second end; and
a driving mechanism configured to move said hose in at least one direction,
wherein at least a portion of said second end of said hose is configured to entrain both a solid material and air.

2. The apparatus of claim 1 further comprising a trolley coupled to at least a portion of said hose body, the trolley configured to engage and travel along a track defining a path, said track configured to be horizontally mountable, wherein at least a portion of said hose is configured to be in motion with said trolley.

3. The apparatus of claim 1 wherein said driving mechanism is coupled to and powered by a motor, said motor is electric, non-electric, hydraulic, actuator, magnetic, pneumatic, or combinations thereof.

4. The apparatus of claim 2 wherein said track is coupled to and driven by said drive mechanism, said track configured to engage and drive said trolley along said path.

5. The apparatus of claim 2 wherein said trolley is coupled to and driven by said drive mechanism.

6. The apparatus of claim 2 wherein said drive mechanism is an integral component of said trolley and said is trolley self-propelled.

7. The apparatus of claim 1 further comprising an end effector coupled to at least a portion of said second end of said hose, said end effector configured to be in fluid communication with said first end of hose, and wherein said end effector is configured to engage a quantity of biomass material.

8. The apparatus of claim 1 wherein said hose comprises an inner hose coaxially contained within an outer hose, said inner hose and outer hose defining a region.

9. The apparatus of claim 8 further comprising a positive pressure source coupled to said outer hose, wherein said region is configured to channel said positive pressure.

10. The apparatus of claim 8 further comprising atmospheric pressure coupled to said outer hose, wherein said region is configured to channel said atmospheric pressure.

11. The apparatus of claim 10 further comprising a negative pressure source coupled to said inner hose.

12. The apparatus of claim 1 wherein at least a portion of said hose body is coupled to a fixed hose mount, said hose mount being horizontally mountable.

13. The apparatus of claim 12 further comprising a pulling wire configured to couple said trolley to at least a portion of said second end of said hose.

14. The apparatus of claim 1 further including a S-pipe having a proximal end rotatably coupled to said trolley and a distal end coupled to said hose.

15. The apparatus of claim 14 wherein said S-pipe is configured to rotate about an axis substantially perpendicular to said trolley.

16. A transfer system for bulk solid biomass fuel, said system comprising:
a bin having an interior cavity sized and shaped for receiving a quantity of biomass, said cavity defining a length, a width, and a height;
a trolley configured to engage and travel along a track defining a path, said track configured to be horizontally mountable to a portion of said bin;
a hose having a body coupled to said trolley, at least a portion of said hose configured to be in motion with said trolley, said body defining a first end and a second end, said first end configured to be in fluid communication with said second end; and
a driving mechanism configured to move said hose in at least one direction.

17. The system of claim 16 further comprising an end effector coupled to at least a portion of said second end of said hose, said end effector configured to be in fluid communication with said first end of hose, and wherein said end effector is configured to engage said quantity of biomass material.

18. The system of claim 16 wherein at least of portion of said first end of said hose is coupled to a discharge port defined on said bin.

19. The system of claim 16 wherein said hose comprises an inner hose coaxial contained within an outer hose.

20. The system of claim 19 further comprising a positive pressure source coupled to said outer hose and a negative pressure source coupled to said inner hose.

21. A method of transferring bulk solid biomass fuel, said method comprising:
providing a trolley configured to engage and travel along a track defining a path, said track configured to be horizontally mountable, said trolley being coupled to a hose, said hose having a body defining a first end and a second end configured to be in fluid communication with said first end, wherein at least a portion of said hose is configured to be in motion with said trolley and configured to engage and convey a quantity of biomass material;
providing a driving mechanism configured to drive said trolley along said track;
driving said trolley along said track; and
conveying said biomass material through said hose.

22. The method of claim 21 further comprising applying a negative pressure source to said hose.
